(19) United States
(12) Patent Application Publication
(10) Pub. No.: US 2025/0268798 A1
(43) Pub. Date: Aug. 28, 2025

(54) GASTRIC SECRETION REINFUSION SYSTEM AND METHOD OF OPERATION

(71) Applicant: THE RESEARCH INSTITUTE AT NATIONWIDE CHILDREN'S HOSPITAL, Columbus, OH (US)

(72) Inventor: Jonathan Gisser, Columbus, OH (US)

(21) Appl. No.: 18/859,696

(22) PCT Filed: Jun. 20, 2023
(86) PCT No.: PCT/US2023/025702

§ 371 Date: Oct. 24, 2024

Related U.S. Application Data
(60) Provisional application No. 63/353,193, filed on Jun. 17, 2022.

(51) Int. Cl. A61J 15/00

(52) U.S. Cl. CPC A61J 15/0015; A61J 15/0069

(57) ABSTRACT

A gastric secretion reinfusion system and method of operation is disclosed. The gastric secretion reinfusion system includes a jejunal tubular member having a jejunal proximal end configured to be coupled to a jejunal feeding port and a jejunal distal end configured to be inserted into a jejunum of a body, and a gastric tubular member having a gastric proximal end configured to be coupled to a gastric drainage port and a gastric distal end configured to be inserted into a stomach of the bod. The gastric secretion reinfusion system further includes a gastric secretion reinfusing conduit that is couplable the jejunal feeding port and the gastric drainage port, the gastric secretion reinfusion conduit for providing a flow path, external to the body, between the stomach and the jejunum.

### CROSS REFERENCES TO RELATED APPLICATIONS

The following application claims priority under 35 U.S. C. § 119(e) to co-pending U.S. Provisional Patent Application Ser. No. 63/353,193 filed Jun. 17, 2022 entitled GASTRIC SECRETION REINFUSION SYSTEM AND METHOD OF OPERATION. The above-identified application is incorporated herein by reference in its entirety for all purposes.

### TECHNICAL FIELD

The present disclosure generally relates to the healthcare field and, more particularly, to a gastric secretion reinfusion system and method of operation that redirects gastric fluid into a jejunum.

### BACKGROUND

Gastrostomy is a surgical procedure that involves inserting a tube directly into a patient's stomach via an artificial opening. One end of the tube remains inside the patient's stomach and the tube extends through the patient's stomach to exit the patient's body such that the other end of the tube is outside the patient's body. Nutrients can be passed through the tube and directly into the patient's stomach for patients who are unable to orally consume an appropriate amount of calories and/or nutrients to promote growth and/or sustain healthy body function. In some cases, there can be slow gastric motility/propulsion which may result in particular foods (e.g., milk) backing up through the artificial opening or refluxing into the patient's esophagus. In such cases, trans pyloric-jejunal feeding tubes (gastrojejunostomy tubes) may be used.

A gastrojejunostomy tube is typically extended into the patient's duoendum/jejunum where continuous feeds are directly transported to the small intestine. Some gastrojejunostomy tubes include a double lumen. One of the lumens is placed in the stomach for feeding, venting, and decompression, while the other lumen is placed in the jejunum for feeding.

Currently, in patients with gastrojejunostomy tubes, gastric drainage in the form of succus, chyme, and other gastric secretions, which are all rich in electrolytes, enzymes, nutrients, and hormones, is discarded. If this biologically active fluid is not received by the small intestine, adverse physiologic consequences including dehydration, dysmotility, malabsorption, malnutrition, electrolyte imbalances, and increased gastric output, which may further exacerbate fluid losses occur. Currently, these biologically active fluid losses are replaced subsequent to the loss occurring with exogenous intravenous fluids that are generally not nutrient dense.

Prior Art FIGS. 1 and 2 show prior art diagrams of a typical transabdominal gastric-jejunal feeding tube 10a inserted in a human patient. The typical gastric-jejunal feeding tube 10a includes a typical jejunal tube 2 that is fluidly independent from a typical stomach tube 4. Due to the fluid independence, gastric drainage from the stomach is discarded, causing the patient from which the fluid was collected to suffer a loss of valuable nutrients.

### SUMMARY

One aspect of the present disclosure comprises a gastric secretion reinfusion (GSR) system, comprising a jejunal tubular member extending between a jejunal proximal end and a jejunal distal end, wherein the jejunal tubular member is dimensioned and configured such that, responsive to the GSR system being inserted into a body, the jejunal proximal end is located outside of the body and is couplable to a jejunal feeding port, and the jejunal distal end is located in a jejunum of the body, a gastric tubular member centrally coupled to the jejunal tubular member extending between a gastric proximal and a gastric distal end, wherein the gastric tubular member is dimensioned and configured such that, responsive to the GSR system being inserted into the body, the gastric proximal end is located outside of the body and is couplable to a gastric drainage port, and the gastric distal end is located in a stomach of the body, and a gastric secretion reinfusion conduit for coupling the gastric drainage port to the jejunal feeding port and providing a fluid connection between the gastric tubular member and the jejunal tubular member.

Another aspect of the present disclosure comprises a method of providing a gastric secretion reinfusion system comprises providing a jejunal tubular member having a jejunal proximal end configured to be coupled to a jejunal feeding port and a jejunal distal end configured to be inserted into a jejunum of a body, and providing a gastric tubular member having a gastric proximal end configured to be coupled to a gastric drainage port and a gastric distal end configured to be inserted into a stomach of the bod. The method further includes providing a gastric secretion reinfusing conduit that is couplable the jejunal feeding port and the gastric drainage port, the gastric secretion reinfusion conduit for providing a flow path, external to the body, between the stomach and the jejunum.

Yet another aspect of the present invention includes gastric secretion reinfusion (GSR) system, including a jejunal tubular member extending between a jejunal proximal end and a jejunal distal end, wherein the jejunal tubular member is dimensioned and configured such that, responsive to the GSR system being inserted into a body, the jejunal proximal end is located outside of the body and is couplable to a jejunal feeding port, and the jejunal distal end is located in a jejunum of the body, wherein the jejunal tubular member defines a first flow path of fluid, the first flow path extending both internally and externally to the body, when the gastric secretion reinfusion system is in use, a gastric tubular member centrally coupled to the jejunal tubular member extending between a gastric proximal and a gastric distal end, wherein the gastric tubular member is dimensioned and configured such that, responsive to the GSR system being inserted into the body, the gastric proximal end is located outside of the body and is couplable to a gastric drainage port, and the gastric distal end is located in a stomach of the body, wherein the gastric member defines a second flow path of fluid, the second flow path extending both internally and externally to the body, when the gastric secretion reinfusion system is in use, and a gastric secretion reinfusion conduit for coupling the gastric drainage port to the jejunal feeding port and providing a fluid connection between the gastric tubular member and the jejunal tubular member, wherein the gastric reinfusion conduit defines a gastric flow path of fluid, the gastric flow path extending externally to the body, when the gastric secretion reinfusion system is in use.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is a prior art diagram of a gastric-jejunal feeding tube system;

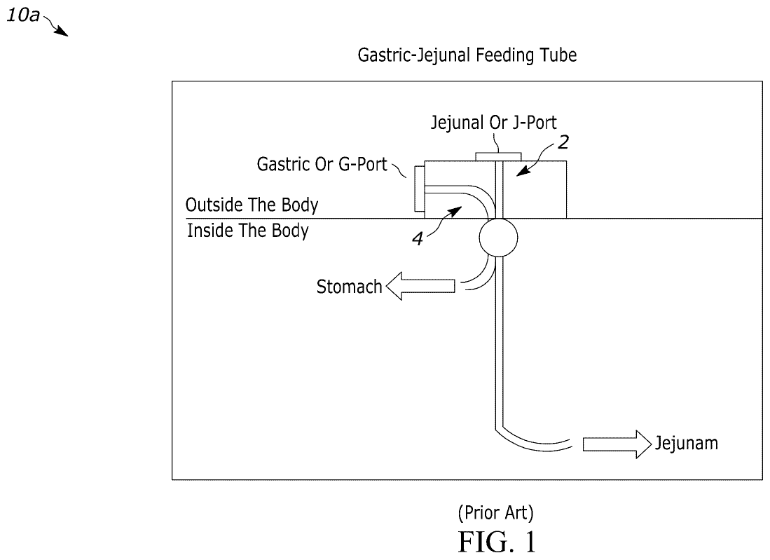

FIG. 2 is a prior art diagram of a gastric-jejunal feeding tube system and flow path;

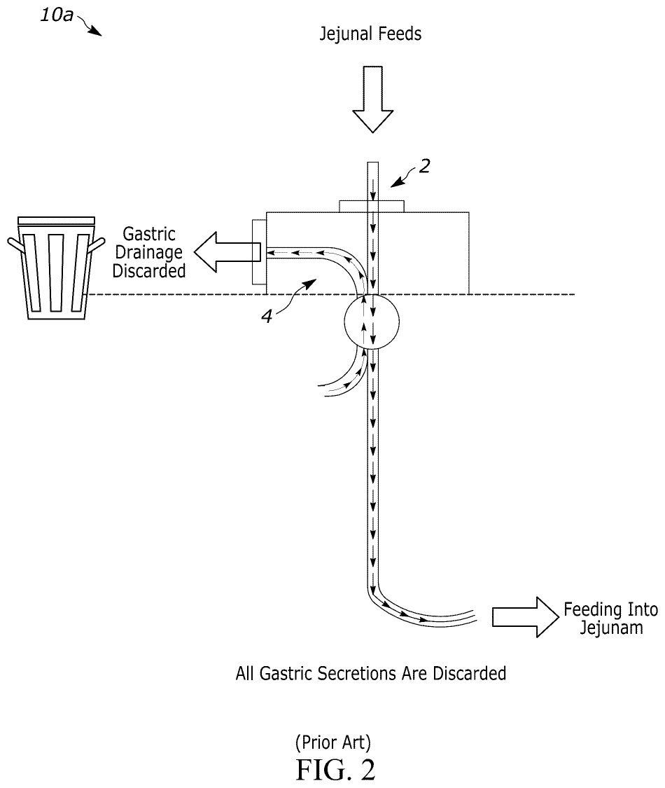

FIG. 3 is a diagram of a gastric secretion reinfusion system in accordance with a first embodiment of the present disclosure;

FIG. 4 is a diagram of a gastric secretion reinfusion system in accordance with a second embodiment of the present disclosure;

FIG. 5 is an in vivo view of a gastric secretion reinfusion system in accordance with one embodiment of the present disclosure;

FIG. 6 is a magnified view of a portion of FIG. 5;

FIG. 7 is a view of a gastric secretion reinfuser, in accordance with one embodiment of the present disclosure; and

FIG. 8 illustrates a flow diagram of a method of use of a gastric secretion reinfusion system in accordance with one embodiment of the present disclosure.

### DETAILED DESCRIPTION

Referring now to the figures wherein like numbered features shown therein refer to like elements throughout unless otherwise noted. The present disclosure relates generally to the healthcare field and, more particularly, to a gastric secretion reinfusion system and method of operation that redirects gastric fluid of into a jejunum.

### Gastric Secretion Reinfusion System

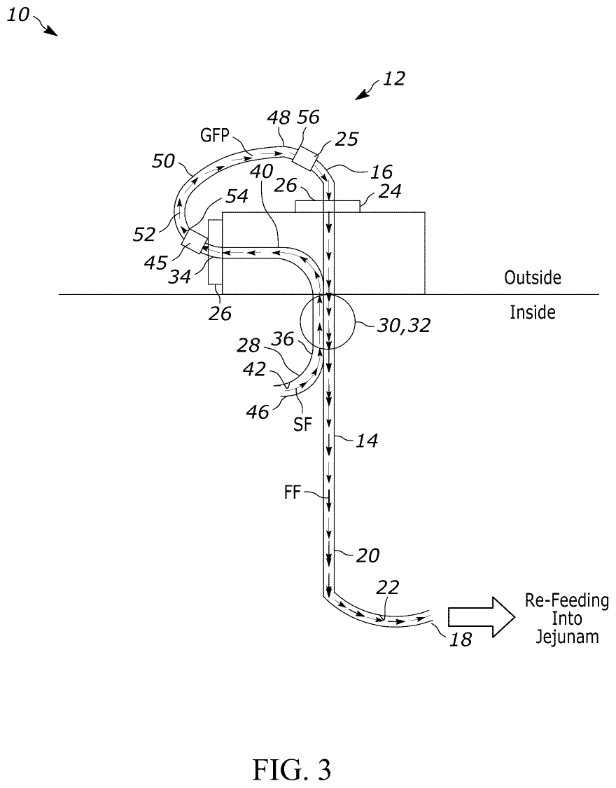

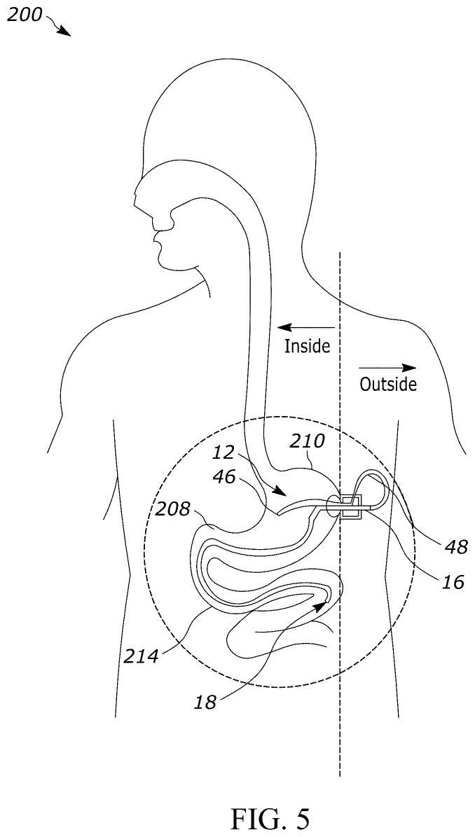

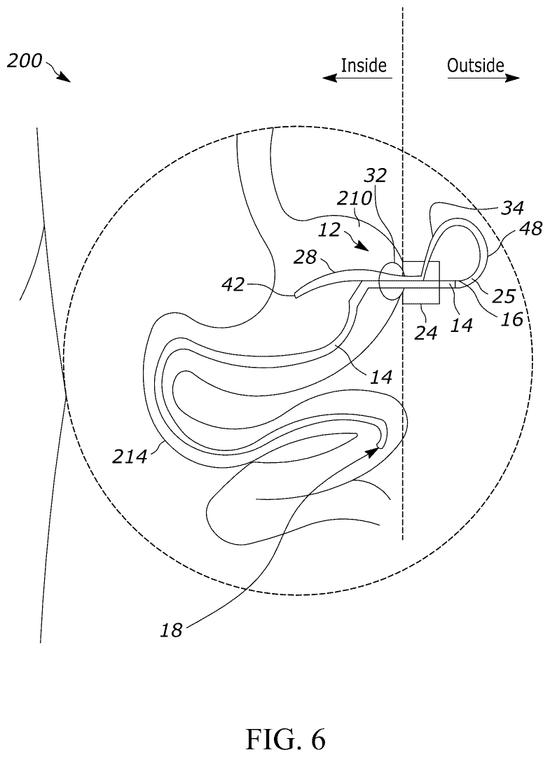

FIGS. 3 and 5-7 show a gastric secretion reinfusion (GSR) system 10 in accordance with one embodiment of the present disclosure. In the illustrated example embodiment of FIGS. 3 and 5-7, the GSR system 10 includes a gastro-jejunal tube 12. The GSR system 10 includes a jejunum (J) tube 14 that extends between a jejunal (J) proximal end 16 and a jejunal (J) distal end 18. It would be appreciated by one of ordinary skill in the art that the J tube 14 could reside in the stomach or other portions of the intestines. In the illustrated example embodiment of FIG. 3, the J tube 14 is substantially cylindrically shaped and defines an outer surface 20 and an inner surface 22, the inner surface defining a passage. It will be appreciated that the J tube 14 could comprises other suitable shapes. In one example embodiment, the J tube 14 is made from a flexible polymer, such as plastic. Responsive to the gastric secretion reinfusion system 10 being inserted into a body 200 of a patient as illustrated in FIGS. 5-6, the J distal end 18 is located inside the body, the J proximal end 16 is located outside the body, and the J tube 14 extends from the inside to the outside of the body.

In one example embodiment, a retention collar 24 is secured to the outer surface 20 of the of the J tube 14, at or near J proximal end 16. As shown in the illustrated example embodiments of FIGS. 5 and 6, the retention collar 24 is secured to the outer surface 20 of outside the body 200. In one example embodiment, the retention collar 24 has a circular shape and defines one or more attachment openings 26. In another embodiment, the retention collar 24 supports the gastro-jejunal tube 12 as it exits the body 200. In yet another example embodiment, the retention collar 24 is one of square, rectangular, oval, or the like. In one example embodiment, the retention collar 24 is made of rigid plastic. In another example embodiment, the retention collar 24 is made of other materials, such as sanitizable materials, of similar weight and strength. In the illustrated embodiment of FIG. 3, the retention collar 24 is connectable and connected to the J tube 14, such that a jejunal/J-port 25 is supported outside of the body 200 (see FIG. 5). In one example embodiment, the retention collar 24 supports the J tube 14 through at least one of a frictional connection, an adhesive connection, or a mechanical connection. The J port 25 comprises an open and closed condition, wherein responsive to being in the open position, the J tube 14, the J port 25, and/or any element coupled to the J port are in fluid communication. In one example embodiment, elements are coupled to the J port 25 via one of a Luer lock connection mechanism, an interference fit, and/or equivalent connection system. As illustrated in the example embodiments of FIG. 3, responsive to the gastro-jejunal tube 12 being in use in the body 200, the J tube 14 defines a first fluid flow path FF, wherein the fluid path extends between the J port 25, through the J proximal end 16 of the J tube 14, and ends at the J distal end 18. In one example embodiment, a fluid flows along the first flow path FF, from the J port 25, through the J tube 14, and through the J distal end 18. In one example embodiment, as illustrated in FIGS. 5 and 6, the J distal end 18 of the J tube 14 is located in a jejunum 214 of body 200 when in use.

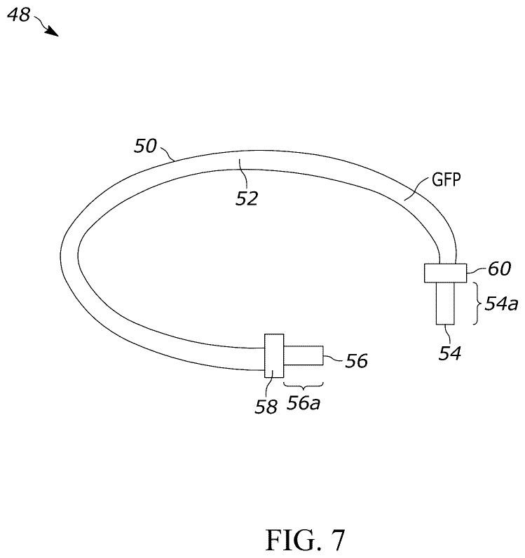

In one example embodiment, the J tube 14 is coupled to a gastric (G) tube 28 through a position assist 30. In this example embodiment, the position assist 30 is a balloon 32. The G tube 28 extends between a gastric (G) proximal end 34 and a gastric (G) distal end 36. In the illustrated example embodiment of FIG. 3, the G tube 28 is substantially cylindrical shaped and includes an outer surface 40, and an inner surface 42, the inner surface defining a passage. Responsive to being inserted into the body 200, the G proximal end 34 of the G tube 28, (see FIG. 5), is located outside of the body. It would be appreciated by one of ordinary skill in the art that the G tube 28 could comprise other shapes. The retention collar 24 is secured adjacent to the outer surface 40 of the G proximal end 34 of the G tube 28. Stated another way, the retention collar 24 is secured to the outer surface 40 outside the body 200. In one example embodiment, the retention collar 24 couples the G tube 28 to the J tube 14 outside the patient's body, wherein the G tube 28 and J tube 14 diverge (see, for example, FIGS. 6-7). In another example embodiment, the G tube 28 and J tube 14 are coupled to each other at multiple points or continuously throughout the lengths of the G tube 28.

In the illustrated example embodiment of FIG. 3, the retention collar 24 is connectable and connected to the G tube 28, such that a gastric/G-port 45 is supported outside of the body 200 (see FIG. 5). In one example embodiment, the retention collar 24 supports the G tube 28 through at least one of a friction connection, an adhesive connection, and/or a mechanical connection. The G port 45 comprises an open and closed condition, wherein responsive to being in the open position, the G tube 28, the G port 45, and/or any element coupled to the G port 45 are in fluid communication. In one example embodiment, elements are coupled to the G port 45 via one of a Luer lock connection mechanism, an interference fit, and/or equivalent connection system. In this example embodiment, the G port 45 is in fluid communication with the G tube 28. Responsive to the gastric secretion reinfusion system 10 being in use, the G distal end 46 of the G tube 28 is located in the stomach 210 (see FIG. 5) of the body 200. Gastric fluid flows from the G distal end 46 of the G tube 28, which is located in the stomach 210, through the G tube 28 to the G port 45 along a second fluid flow path SF (see FIG. 3). In one example embodiment, the second flow path is created by a pressure present in the stomach 210 pushing the fluid along that fluid flow path SF. The second fluid flow path SF begins in the G distal end 46 and extends through the G tube 28, through the G proximal end 34 and the G port 45.

In the illustrated example of FIGS. 3-7, the J port 25 and the G port 45 are connected by a gastric secretion reinfuser 48 (see FIG. 7). The gastric secretion reinfuser 48 is substantially cylindrically shaped and includes an outer surface 50 and an inner surface 52, the inner surface defining a passage. (See FIGS. 3, 7). The gastric secretion reinfuser 48 defines a gastric flow path GFP that extends between first 54 and second 56 ends of the gastric secretion reinfuser 48. One of ordinary skill in the art would recognize that alternate shapes of the gastric secretion reinfuser 48 are contemplated. In one example embodiment, the gastric secretion reinfuser 48 is made from a flexible polymer, such as plastic. In another example embodiment, the gastric secretion reinfuser 48 is made from a sanitizable material. In one example embodiment, the gastric secretion reinfuser 48 has a gastric reinfuser length measured from the first end 54 to the second end 56. In one example embodiment, the gastric reinfuser length is between cm to about cm. In another example embodiment, the gastric reinfuser length is cm. In one example embodiment, the passage defined by the inner surface 52 defines a diameter or width. In one example embodiment, the diameter or width of the passage defined by the inner surface 52 is between cm to about cm. In another example embodiment, the diameter or width of the passage defined by the inner surface 52 is cm. In one example embodiment, the diameter or width of the passage defined by the inner surface 52 is configured to maintain the pressure created in the stomach 210 throughout the gastric reinfuser length and into the J tube 14. In one example embodiment, the gastric secretion reinfuser 48 has a first collar 58 and a second collar 60. In this example embodiment, the first and second collars 58, 60 comprise a locking mechanism, such as a Luer-Lok connection fitting. In another example embodiment, the first and second collars 58, 60 comprise a stop, wherein a first end portion 54a of the gastric secretion reinfuser 48 is inserted into the J port 25 and/or some portion of the J tube 14 until the J port is in contact with the first collar 48 and coupled thereto by a friction fit, and a second end portion 56a of the gastric secretion reinfuser 48 is inserted into the G port 45 and/or some portion of the G tube 28 until the G port is in contact with the second collar 50 and coupled thereto by a friction fit.

As shown in the illustrated example embodiment of FIG. 3, the first end 54 of the gastric secretion reinfuser 48 is coupled to the J port 25 and the second end 56 of the gastric secretion reinfuser 48 is coupled to the G port 45. The first 54 and second 56 ends of the gastric secretion reinfuser 48 are connectable to the J port 25 and the G port 45 through a variety of connection mechanisms such as a Luer-Lok connection fitting, a friction fit, a tension fit, and/or the like. In another example embodiment, the second end 56 of the gastric secretion reinfuser 48 is connected to one arm of a Y connection, wherein a second arm of the Y-connection is available for jejunal infusion, and the final arm of the Y connection is connected to the J port 25. However, it will be appreciated that other attachment features are contemplated (e.g., interference fit). The gastric secretion reinfuser 48 advantageously reroutes the fluid travelling along the second fluid flow path SF to the first fluid flow path FF through the gastric flow path GFP. This allows for the reinfusion of nutritionally rich gastric fluids into the jejunum 214 (see FIG. 5).

The fluid paths followed by feeds, gastric secretions, and/or other fluids in accordance with one example embodiment of the present disclosure will now be described. The first fluid path FF starts when the body 200 is provided a liquid feed that first flows from a point external to the body into the J port 25 of the gastro-jejunal tube 12. The fluid flows along the first fluid path FF from outside to inside the body from the J port 25 to the J proximal end 16 of the J tube 14, through the J tube 14, and through the J distal end 18 of the J tube 14 before the fluid reaches the jejunum 214. The nutritional content of the feed is absorbed by a small intestine of the body 200. The stomach 210 produces gastric fluids that are under pressure. The gastric fluids flow in along the second fluid flow path SF from inside the body 200, from the G distal end 46 of the G tube 28 through the G tube 28, through the G proximal end 34 of the G tube 28 to the G port 45.

The gastric fluid travels from the G port 45 through the first end 54 of the gastric secretion reinfuser 48, through the gastric secretion reinfuser toward the second end 56 of the gastric secretion reinfuser 48 on the gastric flow path GFP, wherein the gastric flow path is external to the body 200. From the second end 56 of the gastric secretion reinfuser 48, the fluid travels through the J port 25, through the J proximal end 16 of the J tube 14, and flows along the first fluid flow path FF through the J tube 14, to the J distal end 18 of the J tube 14, and into the jejunum 214 (see FIG. 5), wherein the first fluid flow path FF extends from outside the body 200 to inside the body. As the pressure in the stomach 210 is greater than pressure in the jejunum 214, the jejunum accepts the secretions from the stomach, and the nutrient rich fluids are advantageously reinfused in the jejunum.

In one example embodiment, the G tube 28 and J tube 14 are operatively coupled but spaced apart, with the first and second flow paths FF, SF having opposing flow paths. In another example embodiment, the G tube 28 and J tube 14 are coupled through the entire length of the G tube 28, and the two flow paths FF, SF are adjacent and opposite to each other.

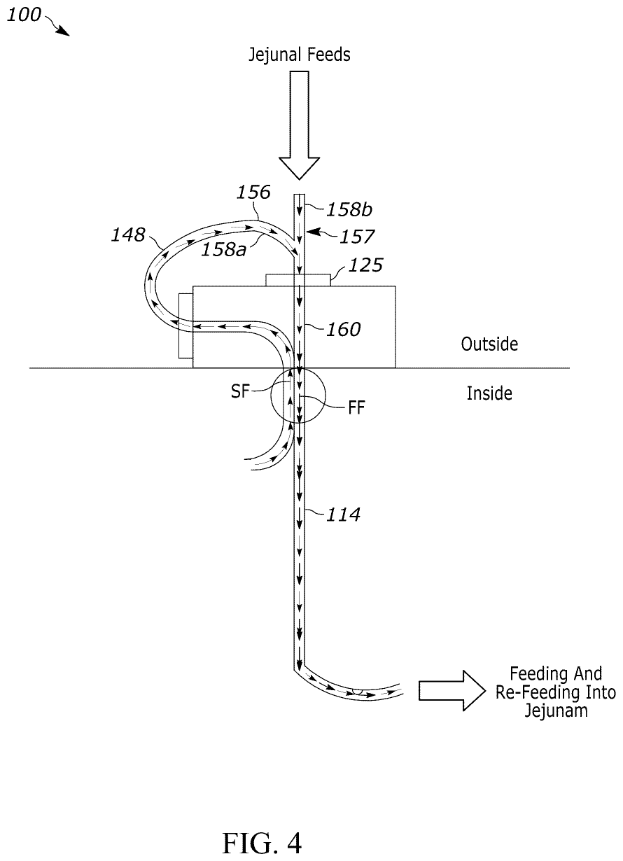

Referring to FIG. 4, the gastric secretion reinfusion system 100a is provided according to another example embodiment of the present disclosure. The gastric secretion reinfusion system 100 in FIG. 4 is substantially similar to the gastric secretion reinfusion system 10 in FIG. 3 with shared features being identified by the same numeral increased by 100, That is, in the second embodiment illustrated in FIG. 4, the gastric secretion reinfusion system 100 comprises all of the features of the gastro-jejunal tube 12 and connections described in the first embodiment, except for that in this embodiment, a Y connection 157 is present. In one example embodiment, a gastric secretion reinfuser 148 defines the Y connection 157 that is coupled to the J port 125 and has bifurcated end portion 158a, 158b. The first end portion 158a is fluidly coupled to the G-port 145, while the second end portion 158b is available for jejunal feed infusions. The Y connection 157 is selectively in communication with the G-port 145 and the jejunal feed infusions, such that the first end portion 158a has an open and close condition, wherein the in the open condition the gastric secretion reinfuser 148 reinfuses gastric fluids into the jejunum via the gastric flow path GFP, and in the close condition there is no fluid communication between the first and second flow paths FF, SF while the j-tube 14 is available for jejunal feed infusions. Further, the second end portion 158b has an opened and closed condition, wherein in the open condition, the first flow path FF is available for infusion, and in a closed condition first flow path FF is unavailable for infusion.

### Method of Use

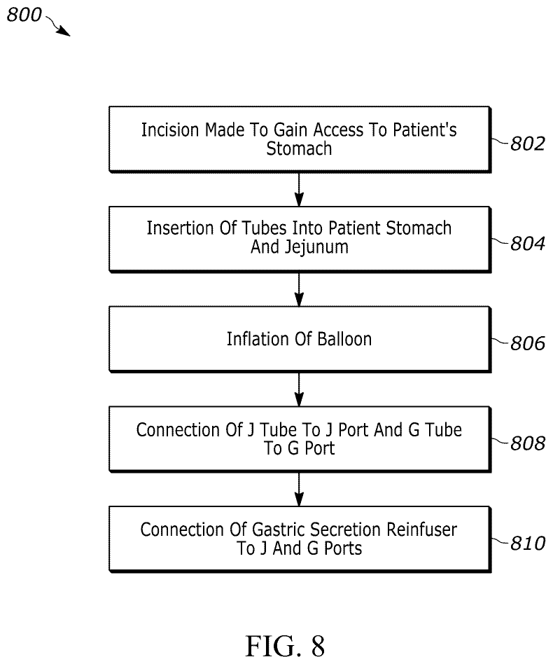

Referring to FIG. 8, a method of use 800 of the gastric secretion reinfusion system 10, 100 is shown according to another example embodiment. At step 802, an incision is made to gain access to the interior of the stomach 210 (see FIG. 5). At 804, the gastro-jejunal tube 12 is inserted into the body 200. In this example embodiment, the J distal end 18 of the J tube 14 and the G distal end 46 of the G tube 28 are inserted into the stomach 210, and the gastro-jejunal tube 12 is advanced into the stomach 210 until the retention collar 24 rests against the patient's skin 212. The J distal end 18 of the J tube 14 is guided into the jejunum 214 and the G distal end 46 of the G tube 28 remains in the stomach 210. An endoscope (not shown) can be used to assist guidance of the J distal end 18 of the J tube 14 into the jejunum 214.

At 806, responsive to the retention collar 24 resting against the patient's skin 212, the balloon 32 is inflated to anchor the position of the gastro-jejunal tubes 12 within the stomach 210 and jejunum 214 of the body 200. The balloon 32 is inflated such that the parts of the human body located between the balloon 32 and the retention collar 24 are “clamped” therebetween. This clamping anchors the position of the tubes 12 relative to the body 200, thereby ensuring proper jejunal 14 and gastric 28 tube placement.

At 808, the gastric secretion reinfuser 48 is connected to the J and G ports 25, 45, respectively, creating a conduit and continuous flow path (e.g., the gastric flow path GFP) through which gastric secretions flow into the jejunum 214. In one example embodiment, the gastro-jejunal tubes 12 are pre-existing in the body 200 of the patient when step 808 is performed. The fluid path starts when the body 200 is provided a liquid feed that first flows external to the body and into the J port 25 of the gastro-jejunal tube 12. From there, the fluid flows from externally to internally of the body 200 through the first fluid flow path FF from the J port 25 to the J proximal end 16 of the J tube 14, through the J tube 14, and through the J distal end 18 of the J tube 14 and enters the jejunum 214 through this first fluid flow path FF. The nutritional content of the feed is absorbed by the small intestine. Meanwhile, the stomach 210 produces gastric fluids that flow along the second fluid flow path SF internal to the body 200 from the G distal end 46 of the G tube 28 through the G tube 28 wherein the fluids travel outside of the body, and through the G proximal end 34 of the G tube 28 to the G port 45.

The gastric fluid travels, externally to the body 200, through the G port 45 through the first end 54 of the gastric secretion reinfuser 48 and into the gastric secretion reinfuser 48 toward the second end 56 of the gastric secretion reinfuser 48 along the gastric flow path GFP. From the second end 56 of the gastric secretion reinfuser 48, the gastric fluid travels into the body 200 through the J port 25, through the J proximal end 16 of the J tube 14, and along the first fluid flow path FF through the J tube 14, through the J distal end 18 of the J tube 14, and into the jejunum 214. The pressure from the stomach 210 is greater than pressure in the jejunum 214, therefore the jejunum accepts the secretions.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes. All documents referenced herein are incorporated by reference in their entireties for all purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A gastric secretion reinfusion (GSR) system, comprising:
a jejunal tubular member extending between a jejunal proximal end and a jejunal distal end, wherein the jejunal tubular member is dimensioned and configured such that, responsive to the GSR system being inserted into a body, the jejunal proximal end is located outside of the body and is couplable to a jejunal feeding port, and the jejunal distal end is located in a jejunum of the body;
a gastric tubular member centrally coupled to the jejunal tubular member extending between a gastric proximal and a gastric distal end, wherein the gastric tubular member is dimensioned and configured such that, responsive to the GSR system being inserted into the body, the gastric proximal end is located outside of the body and is couplable to a gastric drainage port, and the gastric distal end is located in a stomach of the body; and
a gastric secretion reinfusion conduit for coupling the gastric drainage port to the jejunal feeding port and providing a fluid connection between the gastric tubular member and the jejunal tubular member.

2. The gastric secretion reinfusion system of claim 1, wherein the gastric reinfusion conduit creates fluid communication between the gastric drainage port and the jejunal feeding port.

3. The gastric secretion reinfusion system of claim 1, wherein the gastric secretion reinfusion conduit defines a gastric flow path for gastric fluids from the gastric distal end of the gastric tubular member to travel to the jejunal distal end of the jejunal tubular member.

4. The gastric secretion reinfusion system of claim 1, wherein the jejunal tubular member and the gastric tubular member are coupled to a position assist when in use.

5. The gastric secretion reinfusion system of claim 1, wherein a first end of the gastric reinfusion conduit is connectable the jejunal feeding port.

6. The gastric secretion reinfusion system of claim 1, wherein a second end of the gastric reinfusion conduit is connectable the gastric feeding port.

7. The gastric secretion reinfusion system of claim 1, wherein the jejunal tubular member defines a first flow path of fluid, the first flow path extending both internally and externally to the body, when the gastric secretion reinfusion system is in use.

8. The gastric secretion reinfusion system of claim 7, wherein the gastric member defines a second flow path of fluid, the second flow path extending both internally and externally to the body, when the gastric secretion reinfusion system is in use.

9. The gastric secretion reinfusion system of claim 8, wherein the gastric reinfusion conduit defines a gastric flow path of fluid, the gastric flow path extending externally to the body, when the gastric secretion reinfusion system is in use.

10. The gastric secretion reinfusion system of claim 1, wherein the gastric reinfusion conduit comprises a subitizable material.

11. The gastric secretion reinfusion system of claim 1, wherein the gastric reinfusion conduit is coupled to the jejunal gastric member by one of a Luer lock connection mechanism or an interference fit.

12. The gastric secretion reinfusion system of claim 1, wherein the gastric reinfusion conduit is coupled to a y connection, wherein the y connection is concurrently coupled to the jejunal gastric member and has an open connection for nutritional infusion.

13. A method of providing a gastric secretion reinfusion system, the method comprising the steps of:
providing a jejunal tubular member having a jejunal proximal end configured to be coupled to a jejunal feeding port and a jejunal distal end configured to be inserted into a jejunum of a body;
providing a gastric tubular member having a gastric proximal end configured to be coupled to a gastric drainage port and a gastric distal end configured to be inserted into a stomach of the body; and
providing a gastric secretion reinfusing conduit that is couplable the jejunal feeding port and the gastric drainage port, the gastric secretion reinfusion conduit for providing a flow path, external to the body, between the stomach and the jejunum.

14. The method of claim 13, wherein the gastric secretion reinfusion conduit defines a gastric flow path for gastric fluids from the gastric distal end of the gastric tubular member to travel to the jejunal distal end of the jejunal tubular member.

15. The method of claim 13, comprising providing a position assist to secure the jejunal tubular member and the gastric tubular member when in use.

16. The method of claim 13, comprising providing a first end of the gastric reinfusion conduit, wherein the first end is connectable the jejunal feeding port.

17. The method of claim 13, comprising providing a second end of the gastric reinfusion conduit, wherein the second end is connectable the gastric feeding port.

18. A gastric secretion reinfusion (GSR) system, comprising:
a jejunal tubular member extending between a jejunal proximal end and a jejunal distal end, wherein the jejunal tubular member is dimensioned and configured such that, responsive to the GSR system being inserted into a body, the jejunal proximal end is located outside of the body and is couplable to a jejunal feeding port, and the jejunal distal end is located in a jejunum of the body, wherein the jejunal tubular member defines a first flow path of fluid, the first flow path extending both internally and externally to the body, when the gastric secretion reinfusion system is in use;
a gastric tubular member centrally coupled to the jejunal tubular member extending between a gastric proximal and a gastric distal end, wherein the gastric tubular member is dimensioned and configured such that, responsive to the GSR system being inserted into the body, the gastric proximal end is located outside of the body and is couplable to a gastric drainage port, and the gastric distal end is located in a stomach of the body, wherein the gastric member defines a second flow path of fluid, the second flow path extending both internally and externally to the body, when the gastric secretion reinfusion system is in use; and
a gastric secretion reinfusion conduit removably coupled to the gastric drainage port and to the jejunal feeding port and providing a fluid connection between the gastric tubular member and the jejunal tubular member, wherein the gastric reinfusion conduit defines a gastric flow path of fluid, the gastric flow path extending externally to the body, when the gastric secretion reinfusion system is in use.

19. The gastric secretion reinfusion system of claim 18, wherein a y connection is concurrently coupled to the jejunal gastric member and to the gastric reinfusion conduit by one of a Luer lock connection mechanism or an interference fit.

20. The gastric secretion reinfusion system of claim 18, wherein a first end of the gastric reinfusion conduit is connectable the jejunal feeding port and a second end of the gastric reinfusion conduit is connectable the gastric feeding port.
